(19) United States
(12) Patent Application Publication
(10) Pub. No.: US 2013/0321752 A1
(43) Pub. Date: Dec. 5, 2013

(54) LIQUID CRYSTAL DISPLAY DEVICE

(71) Applicant: Japan Display Inc., Minato-ku (JP)

(72) Inventors: Youichi ASAKAWA, Nonoichi-shi (JP); Shigesumi ARAKI, Hakusan-shi (JP)

(21) Appl. No.: 13/905,273

(22) Filed: May 30, 2013

(30) Foreign Application Priority Data
May 30, 2012 (JP) 2012-123477

(51) Int. Cl. G02F 1/1337

(52) U.S. Cl. CPC G02F 1/1337
USPC 349/128

(57) ABSTRACT

According to one embodiment, a liquid crystal display device includes a first substrate including a common electrode, and a pixel electrode which includes a central slit and a peripheral slit which are opposed to the common electrode. The central slit and the peripheral slit are arranged in a first direction and extend in a second direction crossing the first direction, the central slit being formed at a central part of the pixel electrode and having a first width in the first direction, and the peripheral slit being formed at a peripheral part of the pixel electrode and having a second width in the first direction which is less than the first width.

### CROSS-REFERENCE TO RELATED APPLICATIONS

This application is based upon and claims the benefit of priority from Japanese Patent Application No. 2012-123477, filed May 30, 2012, the entire contents of which are incorporated herein by reference.

### FIELD

Embodiments described herein relate generally to a liquid crystal display device.

### BACKGROUND

By virtue of such advantageous features as light weight, small thickness and low power consumption, liquid crystal display devices have been used in various fields as display devices of OA equipment, such as personal computers, and TVs. In recent years, liquid crystal display devices have also been used as display devices of portable terminal equipment such as mobile phones, car navigation apparatuses, game machines, etc.

In general, a liquid crystal display panel of a fringe field switching (FFS) mode or an in-plane switching (IPS) mode is configured such that a liquid crystal layer is held between an array substrate, which includes a pixel electrode and a common electrode, and a counter-substrate. In particular, in the FFS mode, liquid crystal molecules are rotated in a plane parallel to a substrate major surface, by a fringe electric field between the pixel electrode and the common electrode. Thereby, retardation (Δn·d; Δn is a refractive index anisotropy of the liquid crystal layer, and d is a cell gap for holding the liquid crystal layer) of the liquid crystal layer is varied.

When a liquid crystal material (positive-type liquid crystal material) with a positive dielectric constant anisotropy is applied to the liquid crystal layer, liquid crystal molecules are aligned such that their major axes are positioned along a fringe electric field. Thus, when a fringe electric field extending from the pixel electrode toward the common electrode is produced, liquid crystal molecules are raised along an electric field in the vertical direction (cell thickness direction) on the pixel electrode or slits, and a sufficiently high retardation cannot be obtained. Consequently, a modulation ratio per pixel lowers, and a high transmittance cannot be obtained.

On the other hand, when a liquid crystal material (negative-type liquid crystal material) with a negative dielectric constant anisotropy is applied to the liquid crystal layer, liquid crystal molecules are aligned such that their major axes are positioned perpendicular to the fringe electric field. Thus, even in the case of a vertical electric field, liquid crystal molecules are not easily raised, and a relatively high retardation can be maintained. Compared to the case of applying the positive-type liquid crystal material, a higher transmittance can be obtained on the pixel electrode. However, there is a tendency that the transmittance sharply lowers at the outer periphery of the pixel electrode, in particular, in the vicinity of a black matrix for shielding between neighboring pixels. The reason for this is that the dielectric constant anisotropy of the negative-type liquid crystal material is lower than the dielectric constant anisotropy of the positive-type liquid crystal material, and the alignment state of liquid crystal molecules of the negative-type liquid crystal material is not varied by a weak electric field at the outer periphery of the pixel electrode.

### BRIEF DESCRIPTION OF THE DRAWINGS

FIG. 1 is a view which schematically illustrates a structure and an equivalent circuit of a liquid crystal display panel, which constitutes a liquid crystal display device according to an embodiment.

FIG. 2 is a plan view which schematically shows, from a counter-substrate side, the structure of pixels on an array substrate shown in FIG. 1.

FIG. 3 is a view which schematically illustrates a cross-sectional structure including a switching element and a slit of a pixel electrode in one pixel of the liquid crystal display panel shown in FIG. 1.

FIG. 4 is a graph showing a simulation result of voltage-modulation ratio characteristics in a structure example 1 in which a positive-type liquid crystal material is applied and a structure example 2 in which a negative-type liquid crystal material is applied.

FIG. 5 is a graph showing in-plane distributions of transmittances in the structure example 1 and structure example 2.

FIG. 6 is a cross-sectional view which schematically shows structure examples of pixel electrodes in a comparative example and the embodiment.

FIG. 7 is a graph showing in-plane distributions of transmittances in the comparative example and the embodiment.

### DETAILED DESCRIPTION

In general, according to one embodiment, a liquid crystal display device includes: a first substrate including a switching element disposed in each of pixels, a common electrode disposed over a plurality of pixels, an insulation film disposed on the common electrode, a pixel electrode which is electrically connected to the switching element, is disposed in each of the pixels on the insulation film and includes a central slit and a peripheral slit which are opposed to the common electrode, and a first alignment film covering the pixel electrode, the central slit and the peripheral slit being arranged in a first direction and extending in a second direction crossing the first direction, the central slit being formed at a central part of the pixel electrode and having a first width in the first direction, and the peripheral slit being formed at a peripheral part of the pixel electrode and having a second width in the first direction which is less than the first width; a second substrate including a second alignment film which is opposed to the first alignment film; and a liquid crystal layer which is held between the first alignment film and the second alignment film, and is formed of a liquid crystal material having a negative dielectric constant anisotropy.

According to another embodiment, a liquid crystal display device includes: a first substrate including a switching element disposed in each of pixels, a common electrode disposed over a plurality of pixels, an insulation film disposed on the common electrode, a pixel electrode which is electrically connected to the switching element, is disposed in each of the pixels on the insulation film and includes a plurality of slits which are opposed to the common electrode, and a first alignment film covering the pixel electrode; a second substrate including a second alignment film which is opposed to the first alignment film; and a liquid crystal layer which is held between the first alignment film and the second alignment film, and is formed of a liquid crystal material having a negative dielectric constant anisotropy, wherein the plurality of slits are arranged in a first direction and extend in a second direction crossing the first direction, the plurality of slits including at least one central slit having a first width in the first direction, a first peripheral slit located on one of both sides of the central slit and having a second width in the first direction which is less than the first width, and a second peripheral slit located on the other of both sides of the central slit and having the second width in the first direction.

Embodiments will now be described in detail with reference to the accompanying drawings. In the drawings, structural elements having the same or similar functions are denoted by like reference numerals, and an overlapping description is omitted.

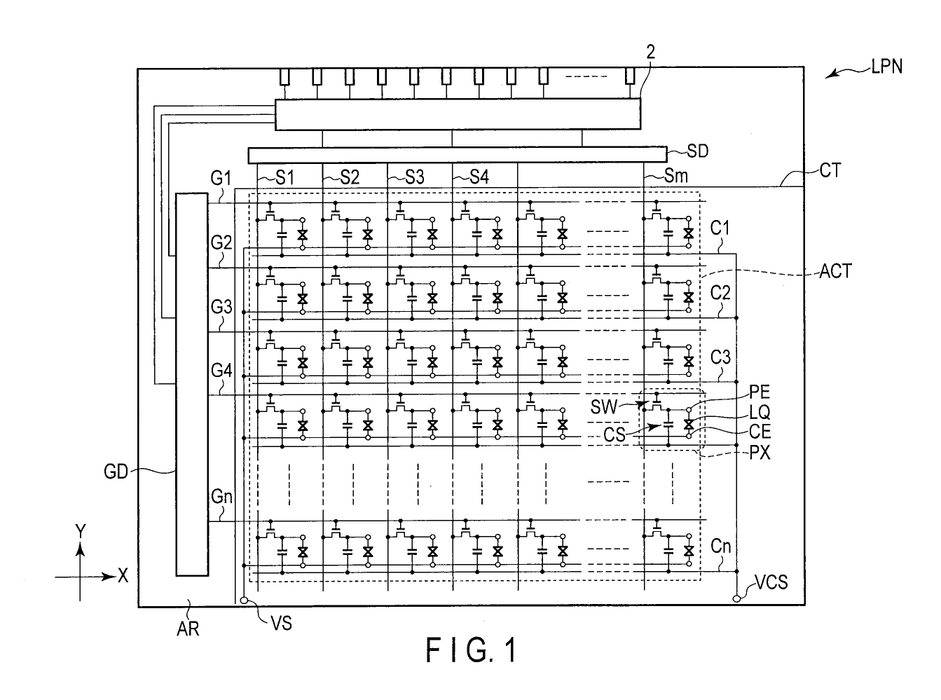

FIG. 1 is a view which schematically shows a structure and an equivalent circuit of a liquid crystal display panel LPN, which constitutes a liquid crystal display device according to an embodiment.

Specifically, the liquid crystal display device includes an active-matrix-type transmissive liquid crystal display panel LPN. The liquid crystal display panel LPN includes an array substrate AR which is a first substrate, a counter-substrate CT which is a second substrate that is disposed to be opposed to the array substrate AR, and a liquid crystal layer LQ which is held between the array substrate AR and the counter-substrate CT. The liquid crystal display panel LPN includes an active area ACT which displays an image. The active area ACT is composed of a plurality of pixels PX which are arrayed in a matrix of m×n (m and n are positive integers).

The array substrate AR includes, in the active area ACT, a plurality of gate lines G (G1 to Gn) and storage capacitance lines C (C1 to Cn) extending in a first direction X, a plurality of source lines (S1 to Sm) extending in a second direction Y which is perpendicular to the first direction X, a switching element SW which is electrically connected to the gate line G and source line S in each pixel PX, a pixel electrode PE which is electrically connected to the switching element SW in each pixel PX, and a common electrode CE which is opposed to the pixel electrode PE. The common electrode CE is commonly formed over a plurality of pixels PX. The pixel electrode PE is formed in an island shape in each pixel PX.

Each of the gate lines G is led out of the active area ACT and is connected to a gate driver GD. Each of the source lines S is led out of the active area ACT and is connected to a source driver SD. Each of the storage capacitance lines C is led out of the active area ACT and is electrically connected to a voltage application module VCS to which a storage capacitance voltage is applied. The common electrode CE is electrically connected to a power supply module VS to which a common voltage is applied. At least parts of the gate driver GD and source driver SD are formed on, for example, the array substrate AR, and are connected to a driving IC chip 2. In the example illustrated, the driving IC chip 2, which functions as a signal source necessary for driving the liquid crystal display panel LPN, is mounted on the array substrate AR on the outside of the active area ACT of the liquid crystal display panel LPN.

In addition, the liquid crystal display panel LPN of the example illustrated is configured to be applicable to an FFS mode or an IPS mode, and includes the pixel electrode PE and common electrode CE on the array substrate AR. In the liquid crystal display panel LPN with this structure, liquid crystal molecules, which constitute the liquid crystal layer LQ, are switched by mainly using a lateral electric field which is produced between the pixel electrodes PE and the common electrode CE (e.g. that part of a fringe electric field, which is substantially parallel to the substrate major surface).

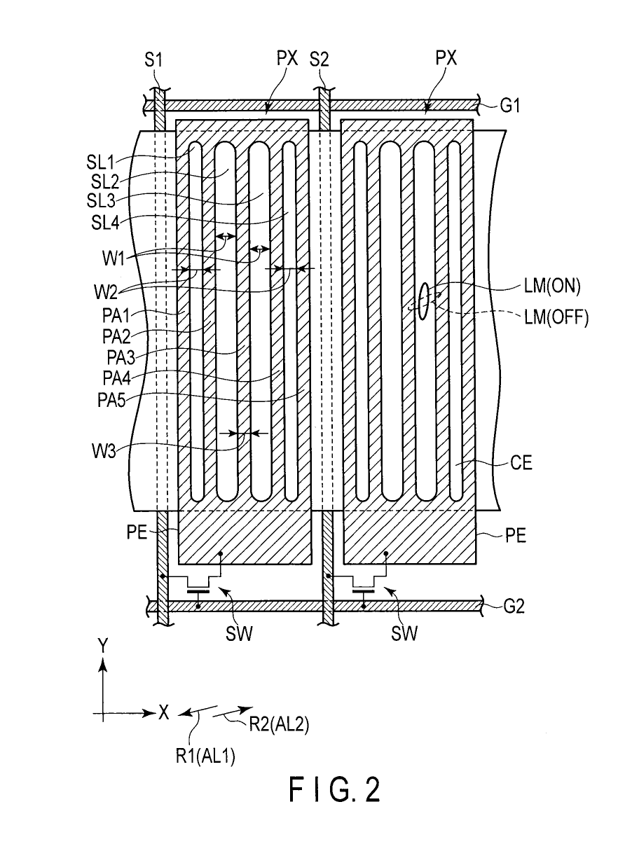

FIG. 2 is a plan view which schematically shows, from the counter-substrate CT side, the structure of pixels PX on the array substrate AR shown in FIG. 1. FIG. 2 illustrates only a main part which is necessary for the description.

A gate line G1 and a gate line G2, which extend in the first direction X, are arranged with a first pitch in the second direction Y. A source line S1 and a source line S2, which extend in the second direction Y, are arranged with a second pitch in the first direction X, which is less than the first pitch. A pixel PX, which is defined by the gate line G1, gate line G2, source line S1 and source line S2, has, for example, a vertically elongated rectangular shape having a less length in the first direction X than in the second direction Y.

In the pixel PX on the left side in FIG. 2, a switching element SW is electrically connected to the gate line G2 and source line S1, and is connected to the pixel electrode PE which is located between the source line S1 and source line S2. Similarly, in the pixel PX on the right side in FIG. 2, a switching element SW is electrically connected to the gate line G2 and source line S2.

The common electrode CE extends in the first direction X. Specifically, the common electrode CE is disposed in each pixel and extends above each source line S, and the common electrode CE is commonly formed over plural pixels PX which neighbor in the first direction X.

The pixel electrode PE of each pixel PX is disposed above the common electrode CE. Each pixel electrode PE is formed in an island shape corresponding to the rectangular pixel shape. In the example illustrated, the pixel electrode PE is formed in a substantially rectangular shape having short sides along the first direction X and long sides along the second direction Y. A plurality of slits SL, which are opposed to the common electrode CE, are formed in each pixel electrode PE. In the example illustrated, the pixel electrode PE includes five electrode portions PA1 to PA5 which are arranged in the first direction X and extend in the second direction Y, and includes four slits SL1 to SL4 which are arranged in the first direction X and extend in the second direction Y. Specifically, each of the slits SL1 to SL4 has a major axis which is parallel to the second direction Y. The shape of the pixel electrode PE will be described later in greater detail.

To begin with, attention is paid to the slits SL1 to SL4. The slits SL1 to SL4 are arranged in the named order in the first direction X. The slits SL2 and SL3 correspond to central slits which are formed in a central part of the pixel electrode PE. The slits SL2 and SL3 are formed to have substantially the same width W1 in the first direction X. The slits SL1 and SL4 correspond to peripheral slits which are formed at a peripheral part of the pixel electrode PE. The slits SL1 and SL4 are formed to have substantially the same width W2 in the first direction X. The width W2 is less than the width W1. Specifically, the width W2 of each of the slit SL1 and slit SL4, which are located on both end sides in the first direction X of the pixel electrode PE, is less than the width W1 of each of the slit SL2 and slit SL3, which are located between the slits SL1 and SL4. In the meantime, although the number of slits located at the central part of the pixel electrode PE is two in the example illustrated, this number is at least one.

Then, attention is paid to the electrode portions PA1 to PA5. The electrode portions PA1 to PA5 are arranged in the named order in the first direction X. The electrode portions PA2 to PA4 correspond to central electrode portions of the pixel electrode PE. The slit SL2 is formed between the electrode portion PA2 and electrode portion PA3. The slit SL3 is formed between the electrode portion PA3 and electrode portion PA4. The electrode portion PA1 and electrode portion PA5 correspond to outermost peripheral electrode portions of the pixel electrode PE. The slit SL1 is formed between the electrode portion PA1 and electrode portion PA2. The slit SL4 is formed between the electrode portion PA4 and electrode portion PA5. The electrode portions PA1 to PA5 have substantially the same electrode width W3 in the first direction X.

In the case of the FFS mode, a higher transmittance is obtained in the vicinity of an edge of each electrode portion (i.e. a boundary with a slit) than in a central part of each electrode portion. Thus, from the standpoint of enhancement in fineness and transmittance, it is desirable to reduce as much as possible the electrode width W3 of each electrode portion. Hence, the electrode width W3 is set at a value close to a limit value in a fabrication process (or a resolution limit value of a mask which is used for patterning the pixel electrode). In other words, the width of the slit, which is formed in the pixel electrode PE, is set at a value which is equal to or greater than the limit value of the fabrication process. In short, the width W2 of each of the slit SL1 and slit SL4 is equal to or greater than the electrode width W3.

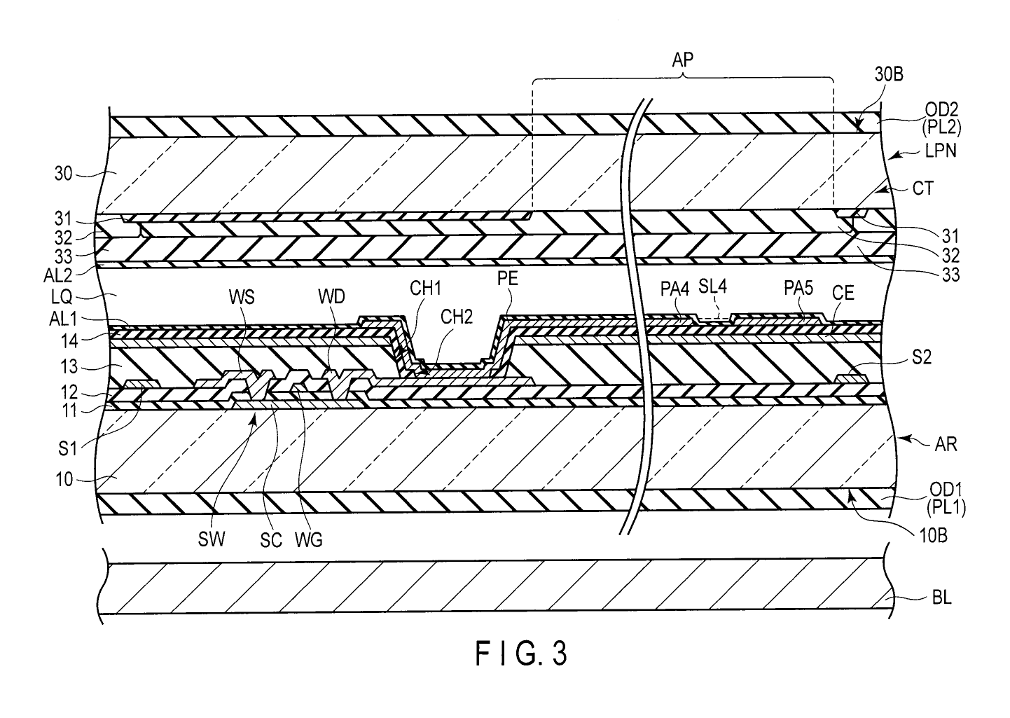

FIG. 3 is a view which schematically illustrates a cross-sectional structure including the switching element SW and the slit SL4 of the pixel electrode PE in one pixel of the liquid crystal display panel LPN shown in FIG. 1.

Specifically, the array substrate AR is formed by using a first insulative substrate 10 with light transmissivity, such as a glass substrate. The array substrate AR includes, on that side of the first insulative substrate 10 which is opposed to the counter-substrate CT, a switching element SW, a common electrode CE, a pixel electrode PE, a first insulation film 11, a second insulation film 12, a third insulation film 13, a fourth insulation film 14, and a first alignment film AL1.

The switching element SW illustrated in FIG. 3 is, for example, a top-gate-type thin-film transistor (TFT). Incidentally, the switching element SW may be of a bottom-gate type. The switching element SW includes a semiconductor layer SC which is formed of, e.g. polysilicon. The semiconductor layer SC is disposed on the first insulative substrate 10. In the meantime, an undercoat layer, which is an insulation film, may be interposed between the first insulative substrate 10 and the semiconductor layer SC. The semiconductor layer SC is covered with the first insulation film 11. In addition, the first insulation film 11 is also disposed on the first insulative substrate 10.

A gate electrode WG of the switching element SW is formed on the first insulation film 11, and is located immediately above the semiconductor layer SC. The gate electrode WG is electrically connected to a gate line (not shown), and is covered with the second insulation film 12. In addition, the second insulation film 12 is also disposed on the first insulation film 11.

A source electrode WS and a drain electrode WD of the switching element SW are formed on the second insulation film 12. Similarly, the source line S1 and source line S2 are formed on the second insulation film 12. The source electrode WS, which is illustrated, is electrically connected to the source line S1. The source electrode WS and drain electrode WD are put in contact with the semiconductor layer SC, respectively, through contact holes penetrating the first insulation film 11 and second insulation film 12. The switching element SW with this structure, as well as the source line S1 and source line S2, is covered with the third insulation film 13. The third insulation film 13 is also disposed on the second insulation film 12. A contact hole CH1, which penetrates to the drain electrode WD, is formed in the third insulation film 13. The third insulation film 13 is formed of, for example, a transparent resin material.

The common electrode CE is formed on the third insulation film 13. Incidentally, the common electrode CE does not extend to the first contact hole CH1 which is formed in the third insulation film 13. The common electrode CE is formed of a transparent, electrically conductive material such as indium tin oxide (ITO) or indium zinc oxide (IZO). The fourth insulation film 14 is disposed on the common electrode CE. Although not illustrated, the fourth insulation film 14 is also disposed on the third insulation film 13. A second contact hole CH2, which penetrates to the drain electrode WD, is formed in that part of the fourth insulation film 14, which covers the first contact hole CH1. The fourth insulation film 14 functions as an interlayer insulation film which is interposed between the common electrode CE and the pixel electrode PE which will be described below. The fourth insulation film 14 is formed of, e.g. silicon nitride (SiNx), so as to have a less film thickness than the third insulation film 13.

The pixel electrode PE is formed on the fourth insulation film 14 and is opposed to the common electrode CE. To be more specific, the pixel electrode PE is electrically connected to the drain electrode WD of the switching element SW through the first contact hole CH1 which penetrates the third insulation film 13, and the second contact hole CH1 which penetrates the fourth insulation film 14. The pixel electrode PE is formed of a transparent, electrically conductive material such as ITO or IZO.

The pixel electrode PE is covered with a first alignment film AL1. Specifically, the first alignment film AL1 covers the electrode portions PA, extends over the slits SL, and covers the fourth insulation film 14. The first alignment film AL1 is formed of a material which exhibits horizontal alignment properties.

On the other hand, the counter-substrate CT is formed by using a second insulative substrate 30 with light transmissivity, such as a glass substrate. The counter-substrate CT includes, on that side of the second insulative substrate 30 which is opposed to the array substrate AR, a black matrix 31, color filters 32, an overcoat layer 33, and a second alignment film AL2.

The black matrix 31 partitions the pixels PX and forms an aperture portion AP. The black matrix 31 is opposed to wiring portions, such as gate lines G, source lines S and switching elements SW, which are provided on the array substrate AR. The color filter 32 is formed in the aperture portion AP and also extends over the black matrix 31. The color filters 32 are formed of resin materials which are colored in mutually different colors, e.g. three primary colors of red, blue and green. Boundaries between the color filters 32 of different colors are located at positions overlapping the black matrix 31 above the source line S1 and source line S2.

The overcoat layer 33 covers the color filters 32. The overcoat layer 33 planarizes asperities on the surface of the black matrix 31 and color filters 32. Specifically, that surface of the overcoat layer 33, which is opposed to the array substrate AR, is substantially planar. The overcoat layer 33 is formed of a transparent resin material.

The overcoat layer 33 is covered with the second alignment film AL2. The second alignment film AL2 is formed of a material which exhibits horizontal alignment properties.

The above-described array substrate AR and counter-substrate CT are disposed such that their first alignment film AL1 and second alignment film AL2 are opposed to each other. In this case, a columnar spacer, which is formed on one of the array substrate AR and counter-substrate CT, creates a predetermined cell gap between the array substrate AR and the counter-substrate CT. The array substrate AR and counter-substrate CT are attached by a sealant in the state in which the cell gap is created therebetween. The liquid crystal layer LQ is composed of a liquid crystal composition including liquid crystal molecules LM which are sealed in the cell gap created between the first alignment film AL1 of the array substrate AR and the second alignment film AL2 of the counter-substrate CT. The liquid crystal layer LQ is formed of, for example, a liquid crystal material with a negative (negative-type) dielectric constant anisotropy.

A backlight BL is disposed on the back side of the liquid crystal display panel LPN having the above-described structure. Various modes are applicable to the backlight BL. As the backlight BL, use may be made of either a backlight which utilizes a light-emitting diode (LED) as a light source, or a backlight which utilizes a cold cathode fluorescent lamp (CCFL) as a light source. A description of the detailed structure of the backlight BL is omitted.

A first optical element OD1 including a first polarizer PL1 is disposed on an outer surface of the array substrate AR, that is, an outer surface 10B of the first insulative substrate 10. In addition, a second optical element OD2 including a second polarizer PL2 is disposed on an outer surface of the counter-substrate CT, that is, an outer surface 30B of the second insulative substrate 30. A first polarization axis of the first polarizer PL1 and a second polarization axis of the second polarizer PL2 are disposed, for example, in a positional relationship of crossed Nicols.

The first alignment film AL1 and second alignment film AL2 are subjected to alignment treatment (e.g. rubbing treatment or optical alignment treatment) in mutually parallel directions in a plane parallel to substrate major surfaces (or an X-Y plane), as illustrated in FIG. 2. The first alignment film AL1 is subjected to alignment treatment in a direction crossing the first direction X, in which the slits SL are arranged, at an acute angle of 45° or less. An alignment treatment direction R1 of the first alignment film AL1 is, for example, a direction which crosses the first direction X at an angle of 5° to 15°. In addition, the second alignment film AL2 is subjected to alignment treatment in a direction which is parallel to the alignment treatment direction R1 of the first alignment film AL1. The alignment treatment direction R1 of the first alignment film AL1 and an alignment treatment direction R2 of the second alignment film AL2 are opposite to each other.

In the meantime, the first polarization axis of the first polarizer PL1 is set to be, for example, substantially parallel to the alignment treatment direction R1 of the first alignment film AL1, and the second polarization axis of the second polarizer PL2 is set to be perpendicular to the alignment treatment direction R1 of the first alignment film AL1.

Next, the operation of the liquid crystal display device with the above-described structure is described.

At an OFF time when such a voltage as to produce a potential difference is not applied between the pixel electrode PE and common electrode CE, no voltage is applied to the liquid crystal layer LQ, and no electric field is produced between the pixel electrode PE and common electrode CE. Thus, liquid crystal molecules LM included in the liquid crystal layer LQ are initially aligned, as indicated by a solid line in FIG. 2, in the alignment treatment directions of the first alignment film AL1 and second alignment film AL2 in the X-Y plane (the direction in which the liquid crystal molecules LM are initially aligned is referred to as “initial alignment direction”).

At the OFF time, part of light from the backlight BL passes through the first polarizer PL1 and enters the liquid crystal display panel LPN. The light, which enters the liquid crystal display panel LPN, is linearly polarized light which is perpendicular to the first polarization axis of the first polarizer PL1. The polarization state of such linearly polarized light hardly varies when the light passes through the liquid crystal display panel LPN at the OFF time. Thus, the linearly polarized light, which has passed through the liquid crystal display panel LPN, is absorbed by the second polarizer PL2 that is in the positional relationship of crossed Nicols in relation to the first polarizer PL1 (black display).

On the other hand, at an ON time when such a voltage as to produce a potential difference is applied between the pixel electrode PE and common electrode CE, a voltage is applied to the liquid crystal layer LQ, and a fringe electric field is produced between the pixel electrode PE and common electrode CE. Thus, the liquid crystal molecules LM are aligned in a direction different from the initial alignment direction in the X-Y plane, as indicated by a broken line in FIG. 2. In the case of a negative-type liquid crystal material, the liquid crystal molecules LM are aligned such that their major axes are substantially perpendicular to the electric field.

At the ON time, linearly polarized light, which is perpendicular to the first polarization axis of the first polarizer PL1, enters the liquid crystal display panel LPN, and the polarization state of such linearly polarized light varies depending on the alignment state of the liquid crystal molecules LM (or the retardation of the liquid crystal layer) when the light passes through the liquid crystal layer LQ. Thus, at the ON time, at least part of the light emerging from the liquid crystal layer LQ passes through the second polarizer PL2 (white display).

As has been described above, according to the present embodiment in which the negative-type liquid crystal material is applied, in a region where a horizontal electric field, which is included in the fringe electric field produced at the ON time and is parallel to the X-Y plane, or a vertical electric field, which is included in the fringe electric field produced at the ON time and is perpendicular to the X-Y plane, is produced, the liquid crystal molecules LM rotate substantially horizontally in the X-Y plane such that their major axes cross the electric field at right angles, and a desired retardation can be obtained. On the other hand, in a comparative example in which a positive-type liquid crystal material is applied, in a region where a vertical electric field, which is included in the fringe electric field and crosses the X-Y plane, is produced, the liquid crystal molecules LM are aligned such that their major axes are raised relative to the X-Y plane, and it is difficult to obtain a desired retardation. Thus, according to the present embodiment, compared to the comparative example, the modulation ratio and transmittance can be improved.

Next, a description is given of differences in characteristics between a structure example 1 in which a positive-type liquid crystal material is applied and a structure example 2 in which a negative-type liquid crystal material is applied.

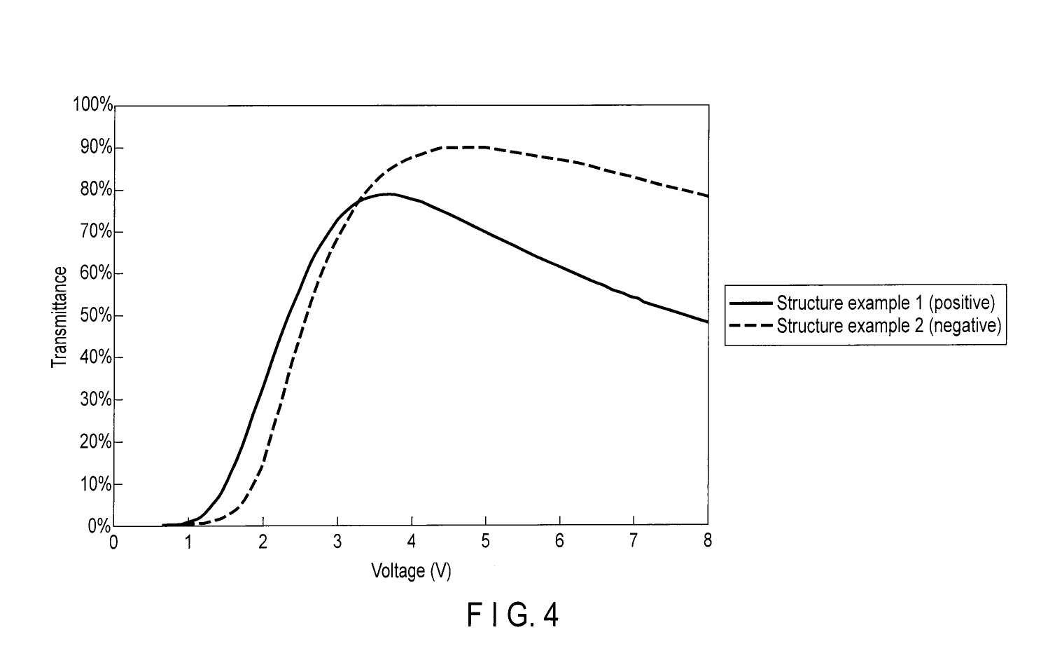

FIG. 4 is a graph showing a simulation result of voltage-modulation ratio characteristics in the structure example 1 and structure example 2.

The abscissa in FIG. 4 indicates an application voltage which is applied to the liquid crystal layer LQ, and the ordinate indicates a transmittance (or modulation ratio). According to the simulation result, the peak transmittance in structure example 1 was about 79.2%, whereas the peak transmittance in structure example 2 was about 90.5%. It was confirmed that a higher transmittance or modulation ratio was obtained in the structure example 2, in which the negative-type liquid crystal material was applied, than in the structure example 1 in which the positive-type liquid crystal material was applied.

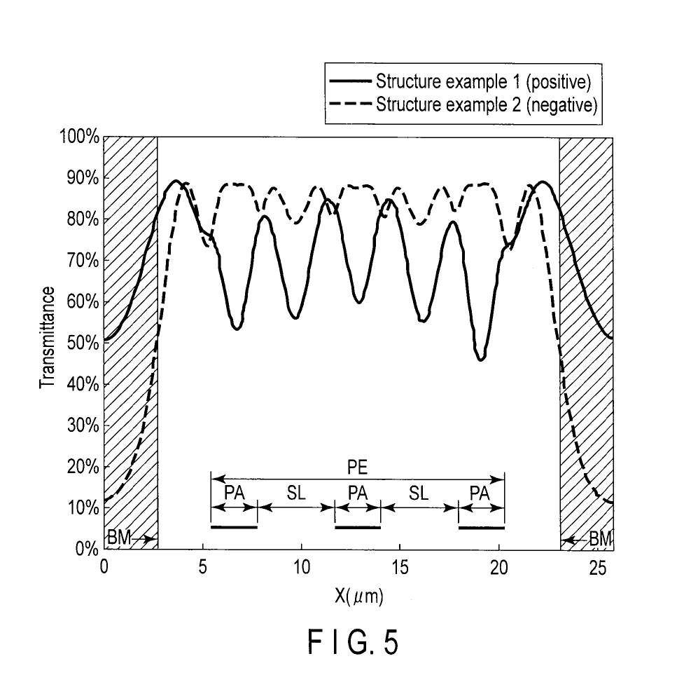

FIG. 5 is a graph showing in-plane distributions of transmittances in the structure example 1 and structure example 2.

The abscissa in FIG. 5 indicates a position (μm) in the first direction X on one pixel electrode PE, and the ordinate indicates a transmittance. The example illustrated in FIG. 5 indicates in-plane distributions of transmittances in the state in which the application voltages, with which the peak transmittances shown in FIG. 4 are obtained, are applied to the liquid crystal layer.

In the structure example 1, the transmittance remarkably lowers at positions above the electrode portions PA of pixel electrode PE and at positions corresponding to the slits SL. This is because the liquid crystal molecules LM are raised by the influence of the vertical electric field of the fringe electric field, as described above.

In the structure example 2, such a tendency is not observed that the transmittance remarkably lowers at positions above the electrode portions PA of pixel electrode PE and at positions corresponding to the slits SL. The reason for this is that, as described above, the liquid crystal molecules LM are hardly affected by the vertical electric field of the fringe electric field, and the liquid crystal molecules LM are not easily raised. Thus, in the structure example 2, compared to the structure example 1, the transmittance per pixel can be enhanced.

However, paying attention to the in-plane distributions illustrated, in the structure example 2, such a tendency was confirmed that the transmittance sharply lowers at the outer periphery of the pixel electrode PE, in particular, in the vicinity of the black matrix BM for shielding between neighboring pixels. The reason for this is that the dielectric constant anisotropy of the negative-type liquid crystal material is lower than the dielectric constant anisotropy of the positive-type liquid crystal material, and the alignment state of the liquid crystal molecules of the negative-type liquid crystal material is not varied by a weak electric field at the outer periphery of the pixel electrode PE.

Taking this into account, in the present embodiment, the transmittance of the pixel electrode PE at a position near the black matrix BM is improved, and thereby the transmittance per pixel can further be enhanced. To be more specific, the width of the pixel electrode PE in the first direction X is increased, and electrode portions are disposed near the black matrix BM. Specifically, as is clear from the above-described in-plane distributions, if the width of the slit or the width of the electrode portion is simply increased, the fringe electric field does not effectively function at the central part of each slit or at the central part of each electrode portion, and the transmittance lowers. As a result, the transmittance per pixel lowers. By contrast, in the present embodiment, the width of the pixel electrode is increased, and slits or electrode portions, upon which the fringe electric field acts, are added. Thereby, without causing a decrease in transmittance at positions above the electrode portions or at positions corresponding to the slits, the transmittance in the region between the pixel electrode PE and black matrix BM is improved, and the transmittance per pixel is enhanced.

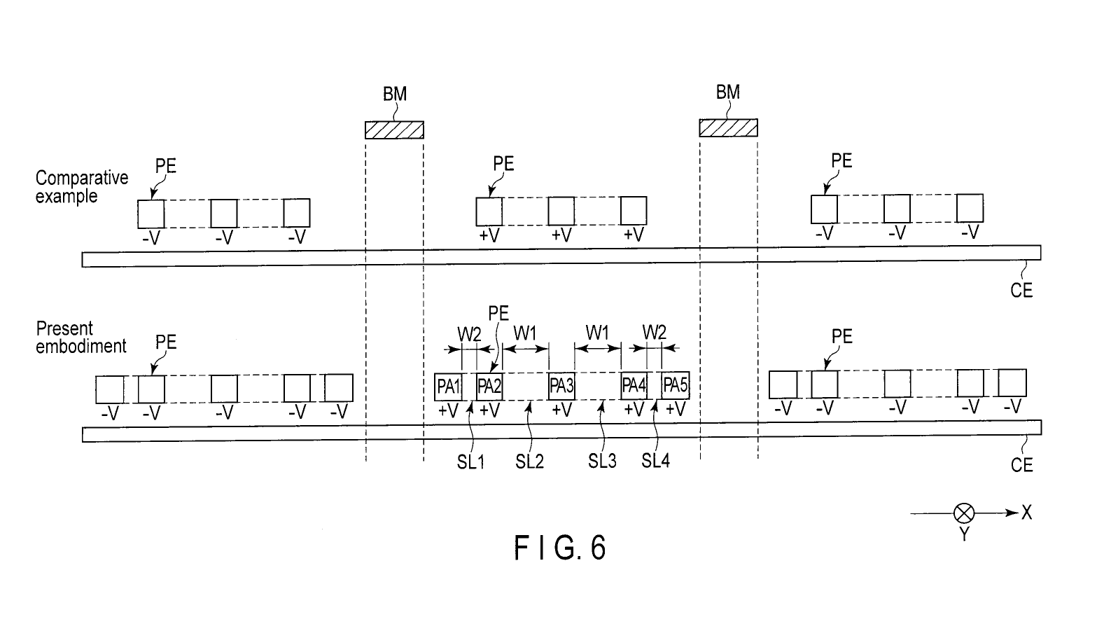

Specifically, as illustrated in FIG. 6, in the present embodiment, the pixel electrode PE includes electrode portions PA1 and PA5 corresponding to outermost peripheral electrode portions, in addition to electrode portions PA2 to PA4 corresponding to central electrode portions. A slit SL1 with a width W2, which is less than a width W1 of a slit SL2 between the electrode portion PA2 and electrode portion PA3, is formed between the electrode portion PA1 and the neighboring electrode portion PA2. In addition, a slit SL4 with the width W2, which is less than the width W1 of a slit SL3 between the electrode portion PA3 and electrode portion PA4, is formed between the electrode portion PA5 and the neighboring electrode portion PA4. At positions above the electrode portions PA1 to PA5 and at positions corresponding to the slits SL1 to SL4, the alignment state of liquid crystal molecules LM is varied by the fringe electric field, and a desired retardation can be obtained. In particular, the width W1 of each of the slits SL2 and SL3, the width W2 of each of the slits SL1 and slit SL4, and the electrode width W3 of each of the electrodes PA1 to PA5 are set at small values so as not to cause a dip (a region where the transmittance locally falls) in the transmittance distribution at regions immediately above these parts. Therefore, a high transmittance can be obtained at regions immediately above the pixel electrode PE.

In addition, when a driving method (e.g. column reversal driving method), in which pixel potentials of pixels neighboring in the first direction X are potentials of opposite polarities, is applied, a horizontal electric field is produced between neighboring pixel electrodes, in addition to the fringe electric field produced in each pixel. In the example illustrated in FIG. 6, the pixel potential of the pixel electrode PE at the central part in FIG. 6 is positive, while the pixel potential of each of the pixel electrodes PE at the right and left in FIG. 6 is negative. In the present embodiment, since the width of the pixel electrode PE in the first direction X is increased, the pixel electrodes PE which neighbor in the first direction X are close to each other. Specifically, the outermost peripheral electrode portions of the respective neighboring pixel electrodes are opposed to each other, and the distance between these outermost peripheral electrode portions is less than the distance between the pixel electrodes in the comparative example. Thus, according to the embodiment, the horizontal electric field, which is produced between the neighboring pixel electrodes, can be increased. Accordingly, since not only the fringe electric field but also the horizontal electric field between the pixel electrodes acts on the liquid crystal molecules LM in the region between the pixel electrode PE and the black matrix BM, it becomes possible to easily vary the alignment state of liquid crystal molecules LM and to obtain a desired retardation. Thereby, the transmittance per pixel can be enhanced.

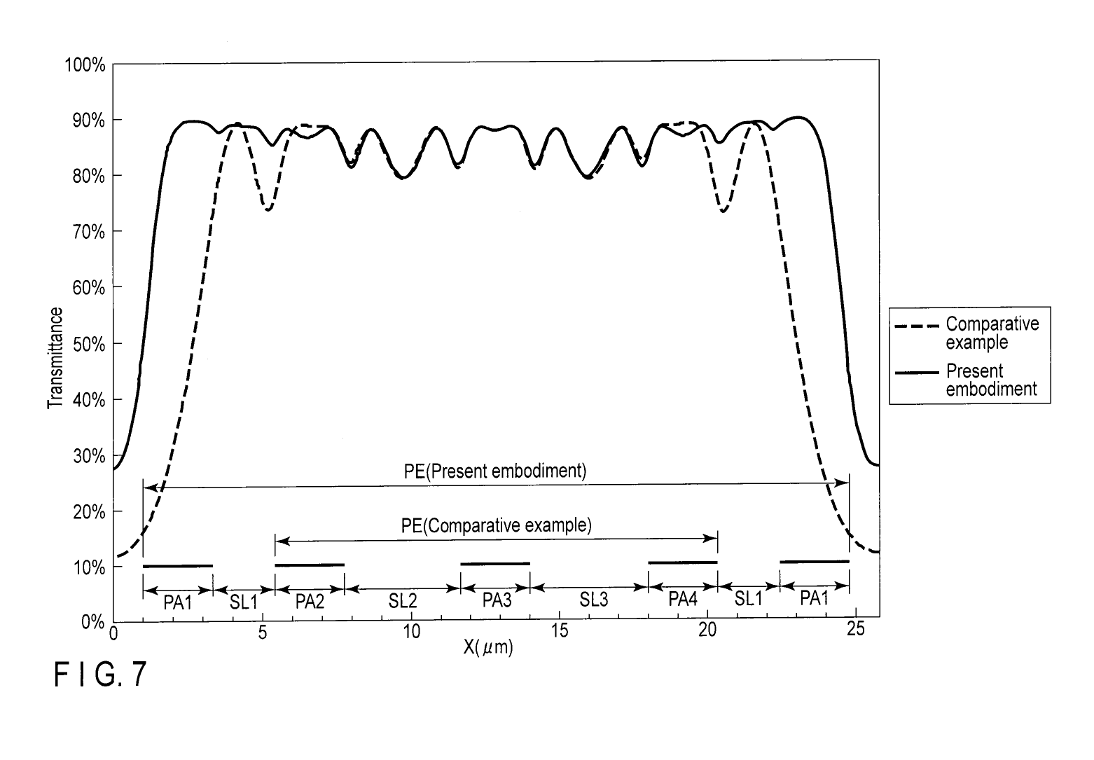

FIG. 7 is a graph showing in-plane distributions of transmittances in the comparative example and the embodiment.

The abscissa in FIG. 7 indicates a position (μm) in the first direction X on one pixel electrode PE, and the ordinate indicates a transmittance. The example illustrated in FIG. 7 indicates transmittances in the state in which voltages, with which peak transmittances are obtained, are applied to the liquid crystal layer.

The present embodiment, as described above, corresponds to the case in which the pixel electrode PE with five electrode portions PA1 to PA5, including two outermost electrode portions, is applied. The comparative example corresponds to the case in which a pixel electrode PE with three electrode portions, not including the outermost electrode portions of the present embodiment, is applied.

Examples of dimensions of the pixel electrode PE in the embodiment are as follows. The width W1 of each of the slits SL2 and SL3 is about 4 μm, the width W2 of each of the slits SL1 and SL4 is about 2 μm, the electrode width W3 of each of the electrode portions PA1 to PA5 is about 2 the width of the black matrix is 5.5 μm, and the interval between neighboring pixel electrodes is 9 to 11 μm.

As has been described above, according to the present embodiment, compared to the comparative example, there is little difference in transmittance at the central part of the pixel electrode PE, but a higher transmittance can be obtained at the peripheral part of the pixel electrode PE. Specifically, according to the embodiment, a high transmittance can be obtained over a wider range than in the comparative example, and the transmittance per pixel can be enhanced.

In the above-described embodiment, the description has been given of the driving method in which pixel potentials of pixels neighboring in the first direction X are potentials of opposite polarities. However, the embodiment is not limited to this driving method. For example, when a driving method (e.g. line reversal driving method), in which pixel potentials of pixels neighboring in the first direction X are potentials of the same polarity, is applied, a horizontal electric field between the neighboring pixel electrodes cannot necessarily be increased. However, by making use of the fringe electric field between the outermost peripheral electrode portions of each pixel electrode PE and the common electrode CE, the alignment state of liquid crystal molecules LM can be varied in the region between the pixel electrode PE and black matrix BM, and a desired retardation can be obtained. Therefore, the transmittance can be enhanced.

As has been described above, according to the present embodiment, a liquid crystal display device, which can improve display quality, can be provided.

In the above-described embodiment, the slits SL of the pixel electrode PE are formed such that the slits SL have major axes which are parallel to the second direction Y. Alternatively, the slits SL of the pixel electrode PE may be formed such that their major axes are parallel to the first direction X or parallel to a direction crossing the first direction X and second direction Y, or the slits SL of the pixel electrode PE may be formed in a bent shape like an angle bracket (<) shape.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a first substrate including a switching element disposed in each of pixels, a common electrode disposed over a plurality of pixels, an insulation film disposed on the common electrode, a pixel electrode which is electrically connected to the switching element, is disposed in each of the pixels on the insulation film and includes a central slit and a peripheral slit which are opposed to the common electrode, and a first alignment film covering the pixel electrode, the central slit and the peripheral slit being arranged in a first direction and extending in a second direction crossing the first direction, the central slit being formed at a central part of the pixel electrode and having a first width in the first direction, and the peripheral slit being formed at a peripheral part of the pixel electrode and having a second width in the first direction which is less than the first width;
a second substrate including a second alignment film which is opposed to the first alignment film; and
a liquid crystal layer which is held between the first alignment film and the second alignment film, and is formed of a liquid crystal material having a negative dielectric constant anisotropy.

2. The liquid crystal display device of claim 1, wherein the pixel electrode includes a plurality of central electrode portions which form the central slit, and an outermost peripheral electrode portion which forms the peripheral slit between the outermost peripheral electrode portion and the central electrode portion.

3. The liquid crystal display device of claim 2, wherein the central electrode portion and the outermost peripheral electrode portion have the same electrode width in the first direction.

4. The liquid crystal display device of claim 3, wherein the second width is equal to or greater than the electrode width.

5. The liquid crystal display device of claim 1, wherein pixel potentials of the pixels neighboring in the first direction are potentials of opposite polarities.

6. The liquid crystal display device of claim 1, wherein a first alignment treatment direction of the first alignment film is a direction crossing the first direction at an acute angle of 45° or less, and a second alignment treatment direction of the second alignment film is parallel to, and opposite to, the first alignment treatment direction.

7. A liquid crystal display device comprising:
a first substrate including a switching element disposed in each of pixels, a common electrode disposed over a plurality of pixels, an insulation film disposed on the common electrode, a pixel electrode which is electrically connected to the switching element, is disposed in each of the pixels on the insulation film and includes a plurality of slits which are opposed to the common electrode, and a first alignment film covering the pixel electrode;
a second substrate including a second alignment film which is opposed to the first alignment film; and
a liquid crystal layer which is held between the first alignment film and the second alignment film, and is formed of a liquid crystal material having a negative dielectric constant anisotropy,
wherein the plurality of slits are arranged in a first direction and extend in a second direction crossing the first direction, the plurality of slits including at least one central slit having a first width in the first direction, a first peripheral slit located on one of both sides of the central slit and having a second width in the first direction which is less than the first width, and a second peripheral slit located on the other of both sides of the central slit and having the second width in the first direction.

8. The liquid crystal display device of claim 7, wherein a first electrode width between the first peripheral slit and the central slit is equal to a second electrode width between the second peripheral slit and the central slit.

9. The liquid crystal display device of claim 8, wherein the second width is equal to or greater than the electrode width.

10. The liquid crystal display device of claim 7, wherein a first alignment treatment direction of the first alignment film is a direction crossing the first direction at an acute angle of 45° or less, and a second alignment treatment direction of the second alignment film is parallel to, and opposite to, the first alignment treatment direction.
